(19) United States
(12) Patent Application Publication
(10) Pub. No.: US 2020/0030813 A1
(43) Pub. Date: Jan. 30, 2020

(54) CONCRETE RECOVERY OR RECLAMATION DEVICE

(71) Applicant: Andrew George Lines, Mundingburra (AU)

(72) Inventor: Andrew George Lines, Mundingburra (AU)

(21) Appl. No.: 16/591,920

(22) Filed: Oct. 3, 2019

Related U.S. Application Data
(63) Continuation-in-part of application No. PCT/AU2018/050305, filed on Apr. 3, 2018.

(30) Foreign Application Priority Data
Apr. 5, 2017 (AU) 2017901238

(51) Int. Cl. B03B 5/04; B03B 5/48; B03B 9/06; B07B 1/28; B07B 13/16

(52) U.S. Cl. CPC B03B 5/04; B03B 5/48; B03B 9/063; B07B 2201/04; B07B 13/16; B07B 2230/01; B07B 1/28

(57) ABSTRACT

A concrete recovery or reclamation device including an entry hopper at an inlet end of the device, at least one screen conveyor inclined upwardly away from the inlet end, at least one vibratory device to cause vibration of the at least one screen conveyor, a liquid dispersion system to disperse liquid over the at least one screen conveyor, a collection sump to collect charged wash liquid, at least one wash liquid outlet from the sump, and at least one reclaimed aggregate material outlet from each at least one screen conveyor.

### TECHNICAL FIELD

The present invention relates generally to reclamation of concrete to separate aggregate material from the cement and wash water and in particular to a unit to reclaim aggregate material with reduced water use.

### BACKGROUND

Concrete reclamation units to separate sand, aggregate and wash water from returned concrete trucks carrying excess or used concrete mix are available.

One such prior art device includes a material entry hopper with a water outlet located thereabove such that when a concrete truck carrying excess or used concrete mix returns, the truck can reverse up to the entry hopper and water can be added directly to the concrete mixing bowl on the truck from the overhead water outlet.

The entry hopper is angled downwardly such that the excess or used concrete mix flows to a lower collection point and at least one screw auger then moves the concrete mix upwardly at an angle whilst wash water is provided in a counter flow direction using gravity. The screw auger is spaced relative to the wall of the channel in which it is provided to move the aggregate against the flow direction of the wash water that separates the aggregate from the cement material in the wash water.

One or more screw auger can be provided to separate different size fractions of aggregate.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a concrete recovery or reclamation device, which may at least partially overcome at least one of the abovementioned disadvantages or provide the consumer with a useful or commercial choice.

With the foregoing in view, the present invention in one form, resides broadly in a concrete recovery or reclamation device including an entry hopper at an inlet end of the device, at least one screen conveyor inclined upwardly away from the inlet end, at least one vibratory device to cause vibration of the at least one screen conveyor, a liquid dispersion system to disperse liquid over the at least one screen conveyor, a collection sump to collect charged wash liquid, at least one wash liquid outlet from the sump, and at least one reclaimed aggregate material outlet from each at least one screen conveyor.

In the context of the present specification, the term “aggregate” includes both sand and coarser aggregate material and there is no limitation on the size of aggregate but there will typically be different sizes of aggregate in a mix and the present invention will typically separate the aggregate into more than one size fraction. Any number of size fractions can be achieved by providing multiple screen conveyors to separate the required size fraction.

The recovery device of the present invention will preferably separate aggregate in a concrete mix, from the cement component of the concrete mix using a combination of vibratory screening and a wash liquid, typically water. In a preferred form, the cement will effectively be washed out in the wash water and then preferably separated from the wash water in order to allow the recycle of wash water as well. The separated cement waste can then be disposed of. Clean wash water may be added to the cement mix prior to unloading the cement mix to be reclaimed into the device, and/or into the device.

In an embodiment of the invention, the device is configured as a base module relative to which an agitation or vibration module is mounted, with the entry hopper, the at least one screen conveyor, the at least one vibratory device, the at least one reclaimed aggregate material outlet and at least portion of the liquid dispersion system all mounted to or a part of the agitation or vibration module. Typically, the agitation or vibration module will be agitated or vibrated relative to the base module and therefore an appropriate mounting assembly is provided between the agitation or vibration module and the base module to allow the agitation or vibration module to be agitated or vibrated relative to the base module but to allow the base module to securely support the agitation or vibration module and be isolated from the vibration.

In an embodiment of the invention, the device includes an agitation or vibration module, wherein the entry hopper, the at least one screen conveyor, the at least one vibratory device, the at least one reclaimed aggregate material outlet and at least portion of the liquid dispersion system all mounted to or a part of the agitation or vibration module. The recovery device may comprise a base module, wherein the agitation or vibration module is mounted relative to the base module.

The device of the present invention includes an entry hopper at an inlet of the device. Typically, the device will have an inlet end and an outlet end and the aggregate material to be separated will transition or be conveyed from the inlet end to the outlet end primarily as a result of the vibration used. The entry hopper may have any size and/or any shape. The entry hopper will typically be sized to allow a concrete truck outlet to dump excess cement mix directly into the hopper. In certain circumstances, the entry hopper may allow more than one concrete truck outlet to dump excess cement mix at the same time.

The entry hopper may be provided with a coarse screen or similar in order to deny entry to overly large material such as may occur if any dried concrete mix exits the concrete truck. Dried concrete mix is typically not capable of being processed by the device of the present invention and therefore, it is preferably screened out prior to entry to the device.

The entry hopper may be provided with a valve in a lower portion in order to spread the cement mix substantially evenly across the width of the screen. Typically, the valve will be provided at a forward side of the entry hopper, preferably directly above the upper screen conveyor. Any suitable valve may be used. For instance, the valve may be a butterfly valve, a slide gate valve, a knife valve, a spreader gate, a flap valve, a pinch valve, or the like. In an embodiment of the invention, the valve may be a flow control valve, a diverter valve or combinations thereof. However, it will be understood that the type of valve may vary on a number of factors, such as the composition and consistency of the material to be separated and the size and shape of the entry hopper.

In an embodiment of the invention, the entry hopper may be provided with a flap valve in a lower portion thereof. In this instance, it is envisaged that the flap valve is biased into the closed condition, for example by a spring or similar that is forced open once sufficient material has been placed in the entry hopper. In a preferred embodiment of the invention, the entry hopper may be provided with a slide gate valve. In this instance, it is envisaged that the slide gate valve may be operated pneumatically, electrically, or manually to adjust the position of the sliding blade relative to the valve body. The slide gate valve may be of any suitable size, shape or configuration. For instance, the slide gate valve may have a rectangular passage cross-section, a square passage cross-section, a circular passage cross-section, or an oval passage cross-section. However, it is understood that the size, shape and configuration of the passage cross-section may vary on a number of factors, such as the size and shape of the entry hopper, the size and shape of the screen conveyor, and the composition and consistency of the material to be separated.

The entry hopper is preferably mounted on the agitation or vibration module such that the entry hopper is also agitated or vibrated. This will also assist with spreading the cement mix across the width of the device.

Normally, the entry hopper is manufactured from metal material due to the conditions in which it will find use. The entry hopper will normally have a relatively wide mouth opening and will generally taper downwardly towards the exit from the entry hopper. The exit from the entry hopper may be any suitable shape in cross-section. For instance, the exit from the entry hopper may have a rectangular outlet, a square outlet, a circular outlet, or an oval outlet. The outlet from the entry hopper will normally be provided or associated with the valve. The outlet from the entry hopper will normally be directly above a lower end of the upper screen conveyor.

The entry hopper will typically have a substantially vertical front wall with the valve located at a lower end of the substantially vertical front wall in order to provide the outlet from the entry hopper. Any angle may be used but a slight angle of between 5°-30° and preferably around 10°-15° is preferred.

The device of the present invention also includes at least one screen conveyor inclined upwardly away from the inlet end. Normally, the agitation or vibration module will include more than one screen conveyor, usually a pair of screen conveyors, a first screen conveyor to separate larger aggregate from sand and smaller aggregate, and a second screen conveyor to separate the sand and smaller aggregate from the wash water containing the cement particulate material. Openings are normally provided in the respective screen conveyors to separate the desired size fraction.

In the context of the present invention, each screen conveyor will typically function to separate aggregate from other material but will also function to convey the separated aggregate from the inlet of the device to the outlet of the device. Each screen conveyor will typically be substantially planar and fixed within the device such that the screen conveyors are vibrated by the at least one vibratory device. Although the screen conveyors are fixed within the device, the angle of the screen conveyors may be adjustable to suit the material to be reclaimed.

In a particularly preferred configuration, each screen conveyor will be provided as at least one plate of material having multiple openings therein. The openings in each of the screen conveyors are typically sized to separate the aggregate of a particular size fraction and above allowing smaller material to fall through. Each screen conveyor may be formed from multiple members to allow for replacement or repair if damaged. Each screen conveyor may be manufactured from any material but a lightweight and robust plastic or composite material is particularly preferred.

Preferably, each screen conveyor is supported along at least a part of respective side edges relative to the agitation or vibratory module. Each screen conveyor will typically be substantially rigid and strong as significant weight in the form of aggregate material may be placed onto the screen conveyor.

There are preferably at least two screen conveyors provided in the device of a preferred embodiment including an upper screen conveyor and a lower screen conveyor. In this configuration, the upper screen conveyor will preferably separate coarse aggregates and larger stones and the like, allowing the sand and smaller material to fall through and the lower screen conveyor will typically separate the sand and smaller material from the cement material and wash water. In this preferred configuration, the upper and lower screen conveyors will typically be spaced apart and extend substantially parallel to one another. Both the upper screen conveyor and the lower screen conveyor are preferably mounted on the external frame of the agitation or vibration module which is typically mounted above the base module.

Preferably, the agitation or vibration module is mounted relative to the base module on a number of rubber or similar bushes in order that the vibration of the agitation or vibration module is substantially isolated from the base module. In a preferred embodiment, four rubber or similar bushes are provided, a pair on each side of the device with one bush of each pair being provided towards the inlet end of the device and one bush from each pair being located towards the outlet end of the device.

The present invention also includes at least one vibratory device to cause vibration of the at least one screen conveyor. One or more vibratory devices may be provided. It is preferred that any vibratory devices are preferably associated with the agitation or vibration module in order to agitate or vibrate the at least one screen conveyor. The vibratory device(s) may provide any motion or movement of the agitation or vibration module and particularly the at least one screen conveyor but preferably a motion which is configured to convey the aggregate on the at least one screen conveyor toward the outlet of the device.

Although the at least one vibratory device may be provided in any location relative to the agitation or vibration module, it is preferred that the vibratory device(s) are provided on top of the agitation or vibratory module, substantially above the at least one screen conveyor. This locates the at least one vibratory device out of the way and means that the at least one vibratory device is not subject to contamination by the wash water or at least contact with wash water is limited.

In the preferred embodiment, the agitation or vibration module including the upper screen conveyor and the lower screen conveyor is preferably provided in a single module and any vibration induced by the at least one vibration device is preferably induced in the entire module including the screen conveyors as well as the entry hopper.

It is preferred that the agitation or vibration module is substantially closed at the entry end of the device and also preferably sealed in order to prevent or at least dramatically minimise the chance that any wash water can escape from the agitation or vibration module other than through the at least one screen conveyor and into the collection sump as the cement charged wash water is potentially environmentally hazardous. In an embodiment of the invention, the agitation or vibration module may be associated with a sump. The agitation or vibration module may be connected to the collection sump of the base module, may be provided with a sump, may be connected to a sump external to the recovery device, or any suitable combination thereof.

In a preferred embodiment of the invention, the agitation or vibration module may be provided with a sump. In this instance, the agitation or vibration module may be directly connected to a sump, eliminating the need for the collection sump associated with the base module of the recovery device. Advantageously, in this embodiment of the invention, the base module of the recovery device may no longer be required. Additionally, during agitation or vibration of the recovery device the charged wash liquid in the sump may be agitated or vibrated, preventing the solids in the charged wash liquid from settling in the sump. In use, it is envisaged that this may effectively self-clean as the solids do not need to be separately removed from the sump after the charged wash liquid is discharged.

The base module of the preferred embodiment of the present invention is typically solid and stable, particularly given that the agitation or vibratory module will be mounted relative to the base module. The base module will typically mount the preferred rubber or similar mounting bushes in order to mount the upper agitation or vibratory module. The preferred collection sump will normally be associated with the base module. The collection sump may be located below the base module and attached or mounted relative thereto or alternatively, the sump can simply be placed or sit below the base module (on the ground for example) and be separate from the base module.

Typically, the base module will be configured as an open frame with a pair of side rails and a pair of end rails in a substantially rectangular configuration. The base module will typically include a number of legs, preferably four, in order to space the open frame above the ground to provide clearance for the collection sump. The preferred rubber or similar mounting bushes will typically be provided relative to the respective side rails.

In an embodiment of the invention, the recovery device may be configured to be mobile. For instance, the recovery device may be provided with wheels, may be adapted for mounting to the chassis of a vehicle (such as a chassis cap, half truck, chassis cab truck), may be adapted for mounting to a trailer for towing by a vehicle, and the like. In a preferred embodiment of the invention, the recovery device may be provided with wheels. It is envisaged that, in use, mounting the recovery device on wheels may assist in vibration dampening.

In an embodiment of the invention, the base module of the recovery device may be configured to be mobile. In this instance, it is envisaged that the base module may be provided with wheels. In a preferred embodiment of the invention, the agitation or vibration module may be configured to be mobile. In this instance, it is envisaged that the agitation or vibration module comprises a sump such that a separate base module comprising a sump may no longer be required. Preferably, the agitation or vibration module may be provided with wheels.

The present invention also includes a liquid dispersion system to disperse liquid over the at least one screen conveyor. The liquid dispersion system of the present invention will normally include at least one pump and a number of conduits in order to transport liquid, normally wash water (the charged wash water will normally include cement particulate and possible a small amount of fines material and may therefore be a slurry and preferably the dispersion system uses clean water or recycled wash water with the bulk of this material removed) around the liquid dispersion system. Typically, there is a liquid supply which may include the sump via a wash water recycle and/or a clean liquid supply.

Typically, the liquid dispersion system will include a fixed dispersion mechanism in order to disperse wash liquid over the at least one screen conveyor. Normally, appropriate fluid conduits are provided in order to allow or transport the wash liquid to the fixed dispersion mechanism. In a preferred form, the fixed dispersion mechanism will include at least one transversely extending conduit above the at least one screen conveyor and where more than one screen conveyor is provided, above at least the upper screen conveyor. The transversely extending conduit will normally be provided with a number of outlet nozzles in order to spray or otherwise disperse wash liquid over the screen conveyor and the material on the screen conveyor. Preferably, the outlet nozzles are directed downwardly toward the screen conveyor and preferably also directed towards the outlet from the device.

Where provided with a number of screen conveyors, the lower screen conveyor is preferably closed at the inlet end and this may form a liquid retention section in order to form a body of liquid above the lower screen conveyor at the inlet end. This will typically assist with the washing of any excess cement material from the sand or finer material.

The liquid dispersion system may use recycled wash water or clean wash water from a water supply or a combination of both.

It is preferred that a further system may be provided above the sump in order to add clean water to the sump and/or to wash any recovered but dried cement material which may accumulate in the sump, toward the outlet from the sump.

The present invention includes a collection sump to collect charged wash liquid. “Charged wash liquid” will normally include cement material which has been separated from the aggregate material. The collection sump will normally be the collection point for the charged wash liquid. The collection sump may be provided or associated with a valve and/or pump in order to drive the wash liquid to a preferred filter or recycle station in order to recover the wash water and separate the cement material (and the bulk of any fines material) from the wash water to allow the wash water to be reused. A filter may be provided on the inlet side of the pump in order to prevent excess solid material travelling through the pump which may damage the pump. However, this will typically depend upon the type of pump used and normally, the charged wash water will be or at least act as a slurry and therefore, a slurry pump will normally be used to move the wash water.

The liquid dispersion system is preferably integrated into the device, and particularly into the agitation or vibration module. The transport conduits and any outlets are typically fixed relative to the agitation or vibration module and mounted preferably to the agitation or vibration module, separately to the base. Preferably, a single connection is provided for inlet wash water and a single outlet is provided from the sump leading to either (or both) recycle or to waste.

The present invention also includes at least one reclaimed aggregate material outlet from each at least one screen conveyor. There are typically, at least one reclaimed aggregate material outlet is provided for each screen conveyor. The reclaimed aggregate material outlets may be located in any suitable position relative to the base module. In an embodiment of the invention, the respective reclaimed aggregate material outlets may be substantially parallel to one another extending from the ends of the respective screen conveyors. In a preferred embodiment of the invention, the respective reclaimed aggregate material outlets may be substantially planar to one another.

The reclaimed aggregate material outlets may extend from any suitable side of the base module. For instance, the reclaimed aggregate material outlets may extend from the same side of the base module, from different sides of the base module, or may extend from the same side of the base module initially and divert towards different sides of the base module. In a preferred embodiment of the invention, the respective reclaimed aggregate material outlets extend from different sides of the base module.

The reclaimed aggregate material outlet may comprise a directional delivery chute. In this instance it is envisaged that the aggregate material may transition or be conveyed from the ends of the respective screen conveyors to the directional delivery chute primarily as a result of the vibration used. The aggregate material entering the directional delivery chute may be directed towards one or both sides of the base module. It is envisaged, that in use, an operator may direct the flow of the coarse aggregate material to one side of the base module and the sand/fine aggregate material to the other side of the base module. Alternatively, the operator may combine the reclaimed aggregate material to form a blend of materials and direct the flow of the reclaimed aggregate material to a side of the base module.

Each reclaimed aggregate material outlet will typically include an outlet plate or similar which may be of any size but will preferably extend across the width of the device, or at least the width of the respective screen conveyor.

The reclaimed aggregate material outlet will preferably maintain the reclaimed aggregate in separate size fractions, in other words, will normally maintain the coarse aggregate material from the preferred upper screen conveyor separately to the sand and small material from the lower screen conveyor.

A mixing flap or similar may be provided in the upper reclaimed aggregate material outlet in order to allow mixing of the coarser material with the sand and small material if desired or required. It is preferred that the mixing flap will be provided as a simple pivoting floor portion which is pivotable between a position in which it is coplanar with the upper aggregate material outlet floor, and an open position in which the coarse aggregate material exiting the upper screen conveyor can fall through an opening formed in the upper aggregate material outlet floor and onto the lower material outlet or alternatively, simply mix with the material exiting the lower aggregate material outlet as it falls from the device.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic isometric view of a concrete recovery or reclamation device according to an embodiment of the present invention;

FIG. 2 is a sectional view of the concrete recovery or reclamation device illustrated in FIG. 1 along line A-A with the outlet aggregate streams maintained separately;

FIG. 3 is a sectional view of the concrete recovery or reclamation device illustrated in FIG. 1 along line A-A with the outlet aggregate streams mixed;

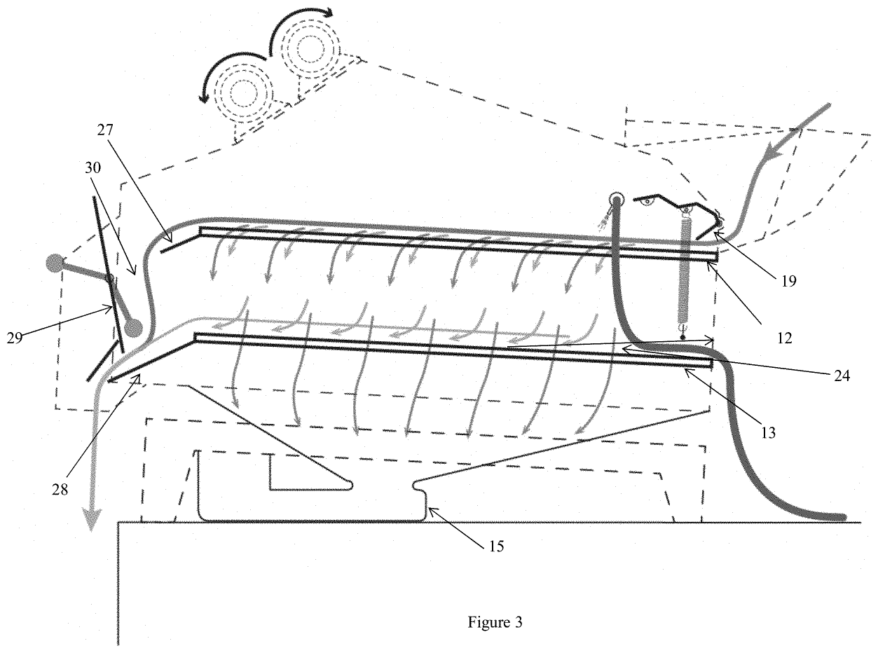

FIG. 4 is a schematic view of a wash water recovery system according to an embodiment of the present invention; and

FIG. 5 is a photographic representation of a concrete recovery or reclamation device according to an embodiment of the invention.

### DETAILED DESCRIPTION

According to a particularly preferred embodiment of the present invention, a concrete recovery or reclamation device 10 is provided.

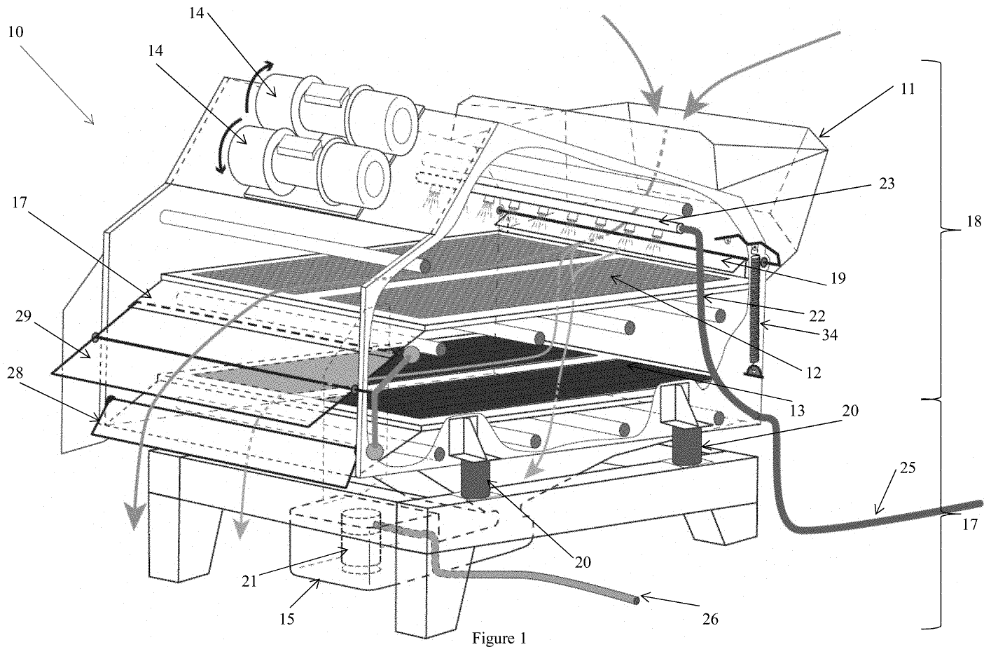

The concrete recovery or reclamation device 10 illustrated schematically in the accompanying FIG. 1 includes an entry hopper 11 at an inlet end of the device, an upper screen conveyor 12 and a lower screen conveyor 13, both inclined upwardly away from the inlet end, at least one vibratory device 14 to cause vibration of the screen conveyors, a liquid dispersion system to disperse liquid over the upper screen conveyor 12, a collection sump 15 to collect charged wash liquid, a wash liquid outlet 16 from the sump 15, and a reclaimed aggregate material outlet from each of the screen conveyors.

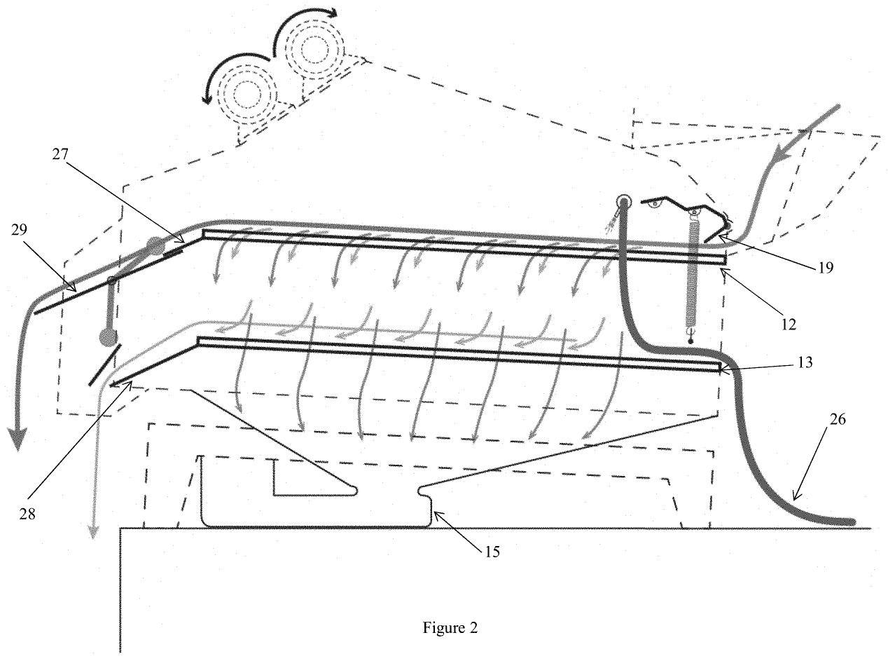

The recovery device of the present invention will preferably separate aggregate from a concrete mix from the cement component of the concrete mix using a combination of vibratory screening and a wash liquid, typically water. In a preferred form, the cement material will effectively be washed out in the wash water and then preferably separated from the wash water in order to allow the recycle of wash water as well (one form of separation station is illustrated in FIG. 2). The separated cement waste can then be disposed of. Clean wash water may be added to the cement mix prior to unloading the cement mix to be reclaimed into the device.

In the embodiment illustrated in FIG. 1, the device 10 is configured as a base module 17 relative to which an upper agitation or vibration module 18 is mounted, with the entry hopper 11, the screen conveyors 12, 13, the vibratory device 14, the reclaimed aggregate material outlets and at least portion of the liquid dispersion system all mounted to or a part of the agitation or vibration module 18. Typically, the agitation or vibration module 18 will be agitated or vibrated relative to the base module 17 and therefore an appropriate mounting assembly is provided between the agitation or vibration module 18 and the base module 17 to allow the agitation or vibration module 18 to be agitated or vibrated relative to the base module 17 but to allow the base module 17 to securely support the agitation or vibration module 18 preferably without transmission of the vibration to the base module 17.

As illustrated, the device 10 will have an inlet and an outlet end and the aggregate material to be separated will transition from the inlet end to the outlet end as a result of the vibration used. The entry hopper 11 may have any size and/or any shape. The entry hopper 11 is typically sized to allow a concrete truck outlet to dump excess cement mix directly into the hopper 11. In certain circumstances, the entry hopper 11 may allow more than one concrete truck outlet to dump excess cement mix at same time.

The entry hopper 11 may be provided with a course screen or similar in order to deny entry to overly large material such as may occur if any dried concrete mix exits the concrete truck. Dried concrete mix is typically not capable of being processed by the device of the present invention and therefore, it is preferably screened out prior to entry to the device.

As illustrated, the entry hopper 11 may be provided with a valve 19 in a lower portion in order to spread the cement mix substantially evenly across the width of the screen conveyors 12, 13. Typically, the valve 19 is provided at a forward side of the entry hopper 11, preferably directly above the inlet end of the upper screen conveyor 12. In an embodiment of the invention where the valve 19 is a flap valve, the flap valve is biased into the closed condition, for example by a spring 34 anchored to an exterior of the device, and the flap valve 19 is forced open once sufficient material has been placed in the entry hopper.

The entry hopper 11 is preferably mounted on the agitation or vibration module 18 such that the entry hopper 11 is also agitated or vibrated. This will also assist with spreading the cement mix across the width of the device.

Normally, the entry hopper 11 is manufactured from metal material due to the conditions in which the device will find use. The entry hopper 11 will normally have a relatively wide opening and will generally taper downwardly towards the lower exit from the entry hopper 11. The exit to the entry hopper 11 comprises an outlet, normally provided or associated with the valve 19. The outlet from the entry hopper 11 will normally be directly above a lower end of the upper screen conveyor 12 as illustrated.

The entry hopper 11 will typically have a substantially vertical front wall with the valve 19 located at a lower end of the substantially vertical front wall in order to provide the outlet from the entry hopper 11.

The agitation or vibration module will normally include more than one screen conveyor, usually a pair of screen conveyors, a first upper screen conveyor 12 to separate larger aggregate from sand and smaller aggregate, and a second, lower screen conveyor 13 to separate the sand and smaller aggregate from the wash water containing the cement particulate material.

In the context of the present invention, each screen conveyor will typically function to separate aggregate from other material but will also function to convey the separated aggregate from the inlet end of the device to the outlet of the device. Each screen conveyor is preferably substantially planar and fixed within the device such that the screen conveyors are moved by the at least one vibratory device 14.

In a particularly preferred configuration, each screen conveyor 12, 13 is provided as one or more plates of material having multiple openings therein. The openings in each of the screen conveyors 12, 13 are typically sized to separate the aggregate of a particular size fraction and above allowing small material to fall through. Each screen conveyor 12, 13 is preferably formed from multiple members to allow for replacement or repair of one or more of the multiple members if damaged. Each screen conveyor 12, 13 may be manufactured from any material but a lightweight and robust plastic or composite material is particularly preferred.

Preferably, each screen conveyor 12, 13 is supported along at least a part of respective side edges relative to the agitation or vibratory module 18. Each screen conveyor 12, 13 will typically be substantially rigid and strong as significant weight in the form of aggregate material may be placed onto the screen conveyor.

In the illustrated preferred configuration, the upper screen conveyor 12 and lower screen conveyor 13 are spaced apart and extend substantially parallel to one another. Both the upper screen conveyor 12 and the lower screen conveyor 13 are preferably mounted on the external frame of the agitation or vibration module 18 which is typically mounted above the base module 17.

In the preferred form illustrated, the agitation or vibration module 18 is mounted relative to the base module 17 on a number of rubber or similar bushes 20 in order that the vibration of the agitation or vibration module 18 is substantially isolated from the base module 17. In a preferred embodiment, four rubber or similar bushes 20 are provided, a pair on each side of the device with one bush 20 of each pair being provided towards the inlet end of the device and one bush 20 from each pair being located towards the outlet end of the device.

One or more vibratory devices 14 may be provided. It is preferred that any vibratory devices 14 are preferably associated with the agitation or vibration module 18 in order to agitate or vibrate the screen conveyors 12, 13. The vibratory device(s) may provide any motion or movement of the agitation or vibration module 18 and particularly the screen conveyors 12, 13 but preferably one which is configured to convey the aggregate on the screen conveyors 12, 13 toward the outlet of the device.

Although the at least one vibratory device 14 may be provided in any location relative to the agitation or vibration module, it is preferred that the vibratory device(s) 14 are provided on top of the agitation or vibratory module 18, substantially above the screen conveyors 12, 13 as shown in FIG. 1. This locates the vibratory device 14 out of the way and means that the vibratory device 14 is not subject to contamination by the wash water or at least, contact with wash water will be limited.

In the preferred embodiment, the agitation or vibration module 18 including the upper screen conveyor 12 and the lower screen conveyor 13 are provided in a single module and any vibration induced by the vibration device(s) 14 is induced in the entire module 18 including both of the screen conveyors 12, 13 as well as the entry hopper 11.

It is preferred that the agitation or vibration module 18 is substantially closed at the entry end of the device 10 and sealed in order to prevent or at least dramatically minimise the chance that any wash water can escape from the agitation or vibration module 18 other than through the lower screen conveyor 13 and into the collection sump 15 as the cement charged wash water is potentially environmentally hazardous.

The base module 17 of the preferred embodiment is typically solid and stable, particularly given that the agitation or vibration module 18 will be mounted relative to the base module 17. The base module 17 will typically mount the preferred rubber or similar mounting bushes 20 in order to mount the upper agitation or vibration module 18. The preferred collection sump 15 will normally be associated with the base module 17. The collection sump 15 is located below the base module 17 and may be attached or mounted relative thereto or alternatively, the collection sump 15 can simply be placed or sit below the base module 17 and be separate from the base module 17.

Typically, the base module 17 will be configured as an open frame with a pair of side rails and a pair of end rails in a substantially rectangular configuration. The base module 17 will typically include a number of legs, preferably four, in order to space the open frame above the ground to provide clearance for the collection sump 15. The mounting bushes 20 will typically be provided relative to the respective side rails.

The present invention also includes a liquid dispersion system to disperse liquid over the at least one screen conveyor. The liquid dispersion system of the present invention will normally include at least one pump 21 and a number of conduits 22 in order to transport liquid, normally water (the charged wash water will normally include cement particular and may be a slurry) around the liquid dispersion system. Typically, there is a liquid supply which may include the sump 14 via a wash water recycle and/or a clean liquid supply.

Typically, the liquid dispersion system will include a fixed dispersion mechanism in order to disperse wash liquid over the upper screen conveyor 12. Normally, appropriate fluid conduits 22 are provided in order to allow or transport the wash liquid to the fixed dispersion mechanism. In a preferred form, the fixed dispersion mechanism will include at least one transversely extending conduit 23 above the upper screen conveyor 12. The transversely extending conduit 23 is provided with a number of outlet nozzles (not shown clearly due to the section) in order to spray or otherwise disperse wash liquid over the upper screen conveyor 12 and the material on the upper screen conveyor 12. Preferably, the outlet nozzles are directed downwardly toward the upper screen conveyor 12 and also directed towards the outlet from the device.

The lower screen conveyor 13 is preferably closed at the inlet end and this forms a liquid retention section in order to form a body of liquid 24 above the lower screen conveyor 13 at the inlet end. This will assist with the washing of any excess cement material from the sand or finer material.

The liquid dispersion system may use recycled wash water or clean wash water from a water supply or a combination of both.

It is preferred that a further liquid dispersion mechanism 24 with a number of nozzles may be provided above the sump 14 in order to add clean water to the sump and/or to wash any recovered but dried cement material which may accumulate in the sump 15, toward the outlet from the sump 14.

“Charged wash liquid”, normally including cement material which has been separated from the aggregate material will travel downwardly though the device to the sump 14. The collection sump 14 may be provided or associated with a valve and/or pump 21 in order to drive the wash liquid to a preferred filter or recycle station (one form of which is shown in FIG. 2) in order to recover the wash water and separate the cement material from the wash water to allow the wash water to be reused. A filter may be provided on the inlet side of the pump in order to prevent excess solid material travelling through the pump which may damage the pump. However, this will typically depend upon the type of pump used and normally, the charged wash water will be or at least act as a slurry and therefore, a slurry pump will normally be used to move the charged wash water.

The liquid dispersion system is preferably integrated into the device, and particularly into the agitation or vibration module 18. The transport conduits and any outlets are typically fixed relative to the agitation or vibration module 18 and mounted preferably to the agitation or vibration module 18, separately to the base 17. Preferably, a single connection 25 is provided for inlet wash water and a single outlet 26 is provided from the sump 14 leading to either (or both) recycle or to waste.

A reclaimed aggregate material outlet is provided for each screen conveyor 12, 13, in other words, an upper reclaimed aggregate material outlet 27 and a lower reclaimed aggregate material outlet 28. Preferably, the respective reclaimed aggregate material outlets are substantially parallel to one another, extending from the end of the respective screen conveyors 12, 13. Each reclaimed aggregate material outlet will typically include an outlet plate or similar which may be of any size but will preferably extend across the width of the device, or at least the width of the respective screen conveyor.

The reclaimed aggregate material outlet will preferably maintain the reclaimed aggregate in separate size fractions, in other words, will normally maintain the coarse aggregate material from the upper screen conveyor 12 separately to the sand and small material from the lower screen conveyor 13.

A mixing flap 29 or similar may be provided in the upper reclaimed aggregate material outlet 27 in order to allow mixing of the coarser material with the sand and smaller material if desired or required. It is preferred that the mixing flap 29 will be provided as a simple pivoting floor portion which is pivotable between a position in which it is coplanar with the upper aggregate material outlet 27 floor and an open position in which the coarse aggregate material exiting the upper screen conveyor 12 can fall through an opening 30 formed in the upper aggregate material outlet 27 floor and onto the lower material outlet 28 or alternatively, simply mix with the material exiting the lower aggregate material outlet 28 as it falls from the device.

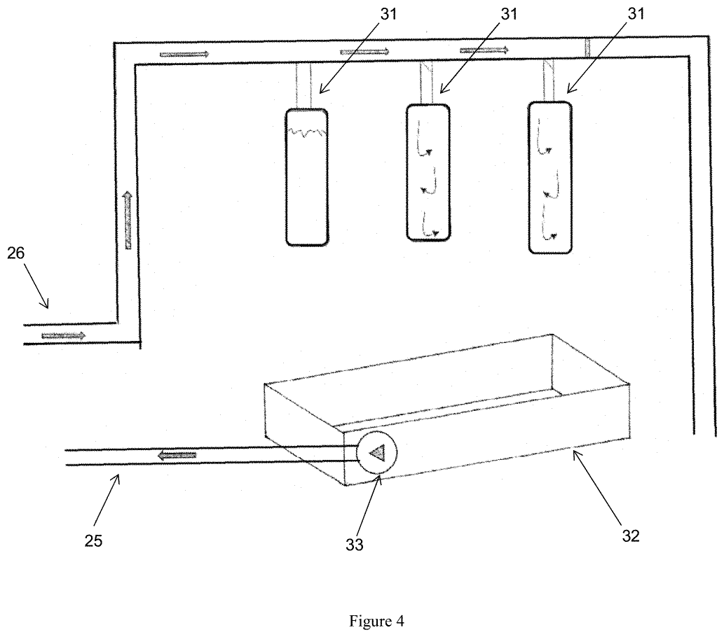

One possible configuration of separation station is illustrated in FIG. 4. The charged wash water enters the separation station via the wash water outlet conduit 26 and is divided between a number of filters 31. The filters of this embodiment are simple bag filters which trap the cement particulate and allow the recycle wash water to flow through the bag filter to be collected in a recycle sump 32. A pump 33 can be provided in the recycle sump 32 to deliver the recycled wash water back to the device via the recycle wash water inlet 25.

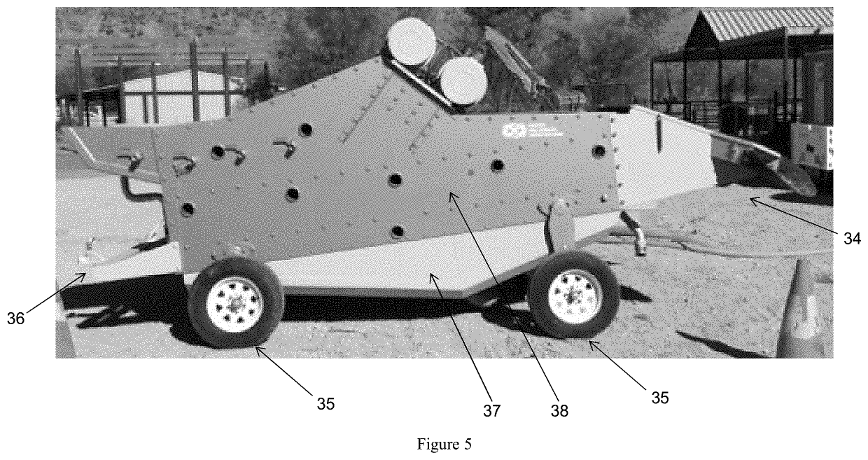

In FIG. 5, a concrete recovery or reclamation device according to an embodiment of the invention is shown. Recovery device 100 comprises an agitation or vibration module 38 with sump 37 directly connected to the agitation or vibration module. In this embodiment of the invention, recovery device 100 does not comprise a base module. It is envisaged that, in use, the vibration of the agitation or vibration module is transferred through the sump connected to the agitation or vibration module preventing any solids in the charged wash liquid from settling. Recovery device 100 is a mobile device and comprises wheels 35 and towing assembly 36 allowing the recovery device 100 to be towed by a powered vehicle. It is envisaged that, in use, wheels 35 may also assist in dampening the vibration from the agitation or vibration module. Recovery device 100 further comprises a directional delivery chute 34 which allows the reclaimed aggregate material to be discharged towards either side of the recovery device.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A concrete recovery or reclamation device including an entry hopper at an inlet end of the device, at least one screen conveyor inclined upwardly away from the inlet end, at least one vibratory device to cause vibration of the at least one screen conveyor, a liquid dispersion system to disperse liquid over the at least one screen conveyor, a collection sump to collect charged wash liquid, at least one wash liquid outlet from the sump, and at least one reclaimed aggregate material outlet from each at least one screen conveyor, wherein the entry hopper is provided with a valve in a lower portion in order to spread the cement mix substantially evenly across the width of the at least one screen conveyor.

2. The concrete recovery or reclamation device as claimed in claim 1, wherein any cement from the concrete is washed out in the charged wash liquid and separated from the charged wash liquid to allow recycle of wash water.

3. The concrete recovery or reclamation device as claimed in claim 1, wherein the wash liquid is water and clean wash water is added to the concrete prior to unloading the concrete to be reclaimed into the concrete recovery or reclamation device, and/or into the concrete recovery or reclamation device.

4. The concrete recovery or reclamation device as claimed in claim 1, including an agitation or vibration module, wherein the entry hopper, the at least one screen conveyor, the at least one vibratory device, the at least one reclaimed aggregate material outlet and at least portion of the liquid dispersion system are all mounted to or are a part of the agitation or vibration module.

5. The concrete recovery or reclamation device as claimed in claim 4, including a base module, wherein the agitation or vibration module is mounted relative to the base module.

6. The concrete recovery or reclamation device as claimed in claim 1, wherein the device has an inlet end and an outlet end and the aggregate material to be separated is conveyed from the inlet end to the outlet end primarily as a result of the vibration used.

7. The concrete recovery or reclamation device as claimed in claim 1, wherein the entry hopper is provided with a coarse screen to deny entry to overly large material.

8. The concrete recovery or reclamation device as claimed in claim 1, wherein an outlet from the entry hopper is directly above a lower end of an upper screen conveyor.

9. The concrete recovery or reclamation device as claimed in claim 1, including pair of screen conveyors, a first screen conveyor to separate larger aggregate from sand and smaller aggregate, and a second screen conveyor to separate the sand and smaller aggregate from the wash liquid containing cement particulate material with a plurality of openings provided in the respective screen conveyors to separate a desired size fraction.

10. The concrete recovery or reclamation device as claimed in claim 9, wherein each screen conveyor is substantially planar and fixed within the device with an angle of each of the screen conveyors adjustable.

11. The concrete recovery or reclamation device as claimed in claim 4, wherein the at least one vibratory device is provided on top of the agitation or vibratory module, substantially above the at least one screen conveyor.

12. The concrete recovery or reclamation device as claimed in claim 4, wherein the agitation or vibration module includes an upper screen conveyor and a lower screen conveyor and any vibration induced by the at least one vibration device is induced in the entire module including the screen conveyors as well as the entry hopper.

13. The concrete recovery or reclamation device as claimed in claim 4, wherein the agitation or vibration module is substantially closed and sealed at an entry end to minimise loss of wash liquid from the agitation or vibration module other than through the at least one screen conveyor and into the collection sump.

14. The concrete recovery or reclamation device as claimed in claim 1, wherein the liquid dispersion system includes at least one pump and a number of conduits in order to transport wash liquid around the liquid dispersion system.

15. The concrete recovery or reclamation device as claimed in claim 14, including a wash liquid recycle and/or a clean liquid supply.

16. The concrete recovery or reclamation device as claimed in claim 1, wherein the liquid dispersion system includes a fixed dispersion mechanism with at least one transversely extending conduit with a number of outlet nozzles to disperse wash liquid over the at least one screen conveyor.

17. The concrete recovery or reclamation device as claimed in claim 16, the outlet nozzles are directed downwardly toward the screen conveyor and also directed towards the outlet from the device.

18. The concrete recovery or reclamation device as claimed in claim 16, wherein the liquid dispersion system is provided with a single connection is provided for inlet wash liquid and a single outlet is provided from the sump leading to recycle and/or to waste.

19. The concrete recovery or reclamation device as claimed in claim 12, wherein a lower screen conveyor is closed at the inlet end to form a liquid retention section in order to form a body of liquid above the lower screen conveyor at the inlet end.

20. The concrete recovery or reclamation device as claimed in claim 1, wherein at least one reclaimed aggregate material outlet is provided for each screen conveyor extending across the width of the respective screen conveyor.

21. The concrete recovery or reclamation device as claimed in claim 1, wherein a mixing flap is provided in an upper reclaimed aggregate material outlet to allow mixing of coarser material with sand and small material.

22. The concrete recovery or reclamation device as claimed in claim 1, wherein the at least one reclaimed aggregate material outlet is a directional delivery chute.
